(19) United States
(12) Patent Application Publication
(10) Pub. No.: US 2021/0076855 A1
(43) Pub. Date: Mar. 18, 2021

(54) PAPER MATERIAL AND PAPER STRAW

(71) Applicant: Hou Jing Sheng Jinghua Co., Ltd., Taoyuan City (TW)

(72) Inventors: Hao-I TSAI, Taichung City (TW); Te-Yi CHAO, Taoyuan City (TW); Li-Yuan HUANG, Kaohsiung City (TW); Bing-Kwan CHENG, Hong Kong (CN); Yuan-Nan TSAI, Tainan City (TW)

(73) Assignee: Hou Jing Sheng Jinghua Co., Ltd., Taoyuan City (TW)

(21) Appl. No.: 16/568,793

(22) Filed: Sep. 12, 2019

(51) Int. Cl. A47G 21/18; B31D 5/00; C09J 11/06

(52) U.S. Cl. CPC A47G 21/18; A47G 2400/10; C09J 11/06; B31D 5/0095

(57) ABSTRACT

The present invention relates to a paper material for producing a paper straw mainly, the paper material includes: a paper and a hot-melt adhesive material; wherein, the hot-melt adhesive material is provided on at least one surface of the paper, including an acrylic acid copolymer 40%˜45% w/w, an ammonia water less than 0.1% w/w or equal to 0.1% w/w and a water 55%˜60%. w/w The hot-melt adhesive material is presented as a dry hot-melt adhesive without viscosity and being transformed to a flow hot-melt adhesive with viscosity while being heated from 80° C.˜200° C. With the combination of hot-melt adhesive material's ingredient percentage, the present invention transfers the hot-melt adhesive from a dry hot-melt adhesive without viscosity to a flow hot-melt adhesive with viscosity for producing the paper straw, so the traditional excessive glue and fall-off problem and mold phenomenon is improved, the traditional adhesive drying process is prevented, raising the production speed of paper straw and reducing the defect rate of producing paper straw significantly.

### FIELD OF THE INVENTION

The present invention relates to a paper material for producing paper straw, especially for a paper structure being coated with adhesive and dried before rolling.

### BACKGROUND OF THE INVENTION

The cuisine culture is evolved and the living standard is improved, package drinks, canned drinks and hand-shaken drinks that made on the spot are everywhere. Therefore, the global consumption of straw is tremendous. The lowest cost plastic straw is the most common straw now; although the plastic straw is convenient, however, it's hard to recycle because user usually litters the plastic after using. This situation will destroy the ecological environment.

The awareness of environmental protection is raising, a reusable metal straw is invented to solve the problem that the traditional plastic straw cause, the metal straw is produced by stainless steel mostly. The advantage of the metal straw is the reusability, however, the metal straw is hard to be popularized to general consumer that wishes convenience because the user has to carry it all the time.

Further, the stainless steel straw needs to be washed or disinfected before reusing it for hygiene. But the aperture of stainless steel straw is too small to clean or disinfect easily, so general consumer worries about the hygiene situation. Therefore, the reusable metal straw can't replace the traditional plastic straw now.

Considering the inconvenience of using metal straw, another paper straw is invented for replacing the plastic straw. Please refer to FIG. 1, a manufacture method of traditional paper straw is transmitting three rolls of composite paper simultaneously, so a first paper material 90, a second paper material 91 and a third paper material 92 pass through a glue machine 93, the contact surfaces between the first paper material 90, the second paper material 91 and the third paper material 92 will be coated with a food-grade wet glue. Then, the first paper material 90, the second paper material 91 and the third paper material 92 are collectively moved to a rolling mechanism 94, so the rolling mechanism 94 spirally twists the first paper material 90, the second paper material 91 and the third paper material 92 to produce a paper pipe 95 with three paper layers. A cut machine 96 cut the paper pipe 95 according to the length of paper straw and a dry machine 97 dry the paper straw to solidify the wet glue.

The general manufacture method in present is using a single paper material, without coated by any glue material, to process the manufacture of coating wet glue afterwards. Therefore, when the wet glue material coating the three paper material, the paper straw mold easily and result the problem in food security because of the exclusive glue problem, the straw layer falls off easily and the situation that the water remains in the paper straw.

Moreover, the glue material concentration of traditional wet paper material is changed in the long-term manufacture status because of the water evaporation, so the operator needs to watch out for diluting water into the traditional wet paper material. If the liquid ingredient of the glue material is not enough, the surface of the glue material will be dry and reduce the viscosity, causing pseudo attachment and the layer of straw falls off easily. On the contrary, if the liquid ingredient of the glue material is too much, the viscosity will be reduced as well and hard to dry. As a result, it is necessary to improve the paper material used by paper straw.

### SUMMARY OF THE INVENTION

A primary object of the present invention is providing a dry paper material, the paper material presents a dry status when the a special hot-melt adhesive material being provided on it. While producing paper straw afterwards, the traditional excessive glue problem, falls off easily problems and mold phenomenon won't be happened, and the viscosity is higher 20%˜30% than the traditional wet adhesive paper.

A second object of the present invention is preventing the adhesive drying process that the manufacture method of traditional paper straw must have, so the production speed can be accelerated significantly and the defect rate of paper straw production can be reduced.

To achieve the above and other objects, the present invention exposes a paper material for producing a paper straw mainly, the paper material includes: a paper and a hot-melt adhesive material. The hot-melt adhesive material is provided on at least one surface of the paper, includes an acrylic acid copolymer 40%˜45% w/w, an ammonia water less than 0.1% w/w or equal to 0.1% w/w and a water 55%˜60%. w/w The hot-melt adhesive material is presented as a dry hot-melt adhesive without viscosity and being transformed to a flow hot-melt adhesive with viscosity while being heated from 80° C.˜200° C.

Wherein, the dry hot-melt adhesive includes a dry adhesive on the outer surface and a flow adhesive being covered by the dry adhesive completely. The dry adhesive presents a status without viscosity and the flow adhesive presents a status with viscosity. The dry adhesive is broken after being heated, making the flow adhesive overflows the dry adhesive and mixing with the dry adhesive to form the flow hot-melt adhesive. The flow hot-melt adhesive exhausts the water to form a solid hot-melt adhesive after being heated for 0.1 second˜60 seconds.

Moreover, the present invention exposes a paper straw, including: an outer paper layer, a middle paper layer, an inner paper layer and two hot-melt adhesive materials. One of the two hot-melt adhesive materials is connected between the outer paper layer and the middle paper layer, the other of the two hot-melt adhesive materials is connected between the middle paper layer and the inner paper layer. The hot-melt adhesive material includes an acrylic acid copolymer 40%˜50% w/w, an ammonia water less than 0.1% w/w or equal to 0.1% w/w and a water 55%˜60% w/w. The hot-melt adhesive is presented as a dry hot-melt adhesive without viscosity and being transformed to a flow hot-melt adhesive while being heated from 80° C.˜200° C.

Wherein, the dry hot-melt adhesive includes a dry adhesive on the outer surface and a flow adhesive being covered by the dry adhesive completely. The dry adhesive presents a status without viscosity and the flow adhesive presents a status with viscosity. The dry adhesive is broken after being heated, making the flow adhesive overflows the dry adhesive and mixing with the dry adhesive to form the flow hot-melt adhesive.

The flow hot-melt adhesive exhausts the water to form a solid hot-melt adhesive after being heated for 0.1 second˜60 seconds. The width of the outer paper layer is larger than the width of middle paper layer and the width of the middle paper layer is larger than the width of inner paper layer. In a operable embodiment, the size difference of width between the outer paper layer, the middle paper layer and the inner paper layer is 0.5 mm.

The characteristic of present invention is the combination of hot-melt adhesive material's ingredient percentage, transferring the hot-melt adhesive from a dry hot-melt adhesive without viscosity to a flow hot-melt adhesive with viscosity, so the traditional excessive glue and fall-off problem and mold phenomenon won't happen while producing the paper straw afterwards. Moreover, the present invention paper straw preventing the traditional adhesive drying process, raises the production speed of paper straw and reduces the defect rate of producing paper straw.

### BRIEF DESCRIPTION OF THE DRAWINGS

The structure and the technical means adopted by the present invention to achieve the above and other objects can be best understood by referring to the following detailed description of the preferred embodiments and the accompanying drawings, wherein:

FIG. 1 is a schematic view illustrating a traditional method for manufacturing a paper straw;

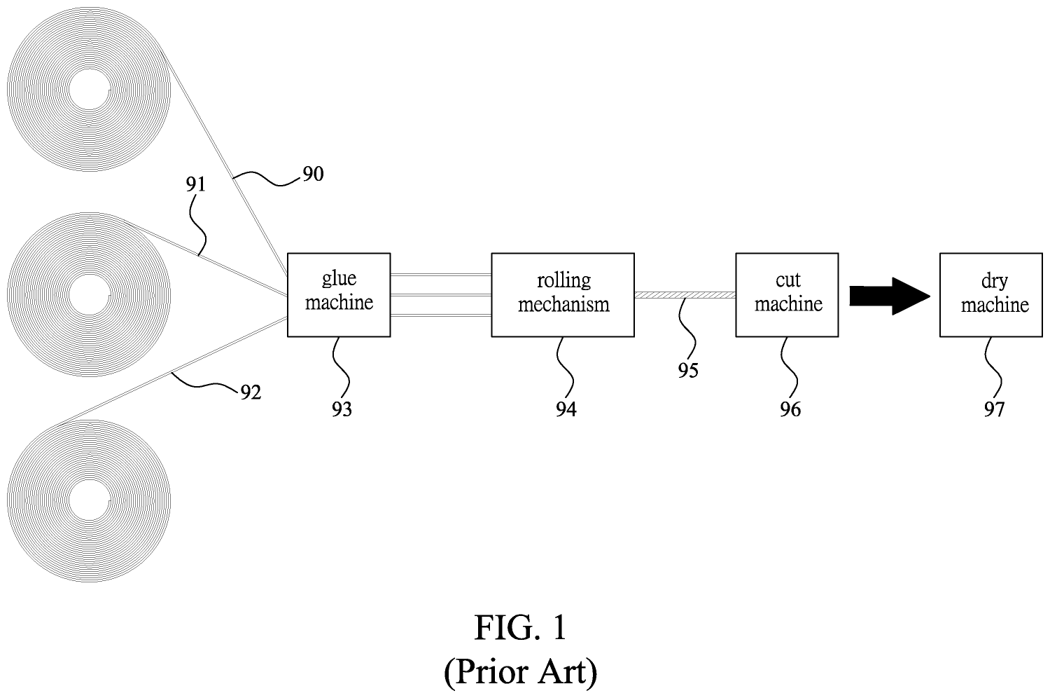

FIG. 2 is a producing flowchart illustrating the present invention paper material;

FIG. 3 is a cross-section schematic view illustrating the present invention paper material transforming from the dry status to the flow status;

FIG. 4 is a cross-section schematic view illustrating the present invention paper material transforming from the flow status to the solid status;

FIG. 5 is a producing flowchart illustrating the present invention paper straw; and

FIG. 6 is a cross-section view illustrating the forming of the present invention paper straw.

### DETAILED DESCRIPTION OF THE PREFERRED EMBODIMENTS

The present invention will now be described with some preferred embodiments thereof and by referring to the accompanying drawings for realizing the structure, usage and characteristic of the present invention better.

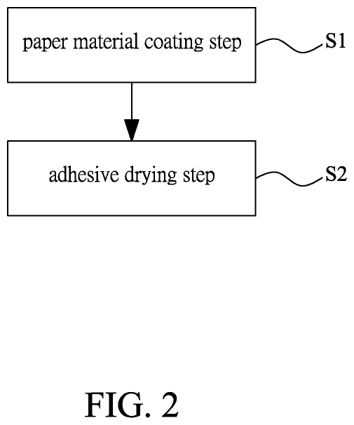

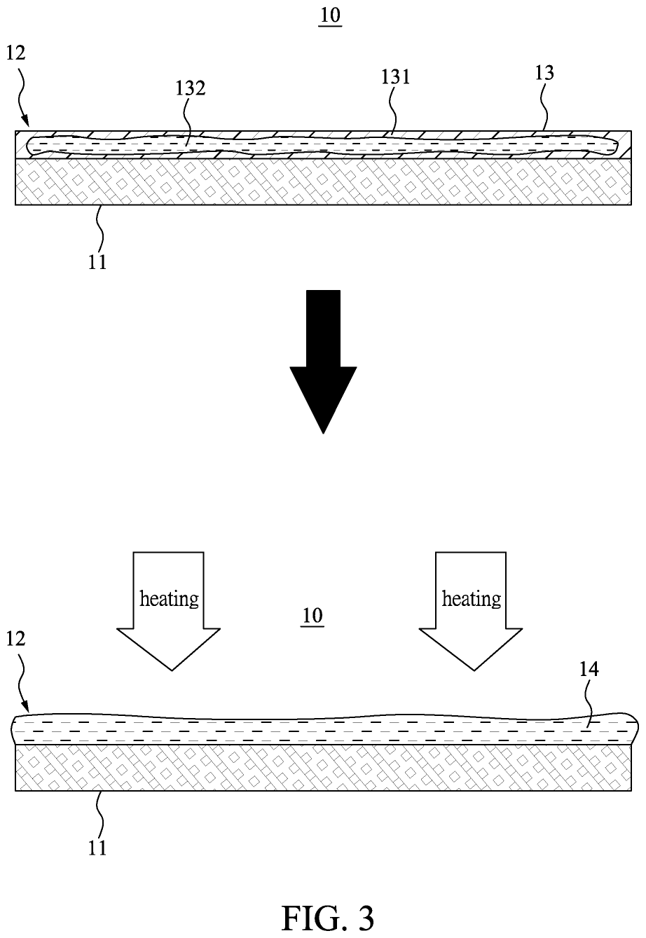

Please refer to FIG. 2 and FIG. 3. The present invention paper material 10 is produced by the following steps: a paper material coating step S1: providing a flow hot-melt adhesive on at least one surface of a paper to form a processed paper material; an adhesive drying step S2: drying the flow hot-melt adhesive of the processed paper material in 40° C.˜80° C., transforming the flow hot-melt adhesive to the dry hot-melt adhesive, forming the paper material for processing a paper straw.

The structure of paper material 10 includes a paper 11 and a hot-melt adhesive material 12 being provided on at least one surface of the paper 11. The hot-melt adhesive material 12 includes an acrylic acid copolymer 40%˜45% w/w, an ammonia water less than 0.1% w/w or equal to 0.1% w/w and a water 55%˜60%. w/w Wherein, the hot-melt adhesive material 12 is presented as a dry hot-melt adhesive without viscosity at first, transformed from the dry hot-melt adhesive 13 to a flow hot-melt adhesive 14 with viscosity while being heated in 80° C.˜200° C.

As shown in the drawing. The dry hot-melt adhesive 13 includes a dry adhesive 131 on the outer surface and a flow adhesive 132 being covered by the dry adhesive 131 completely. The dry adhesive 131 is broken after being heated, making the flow adhesive 132 overflows the dry adhesive 131 and mixing with the dry adhesive 131 to form the flow hot-melt adhesive 14.

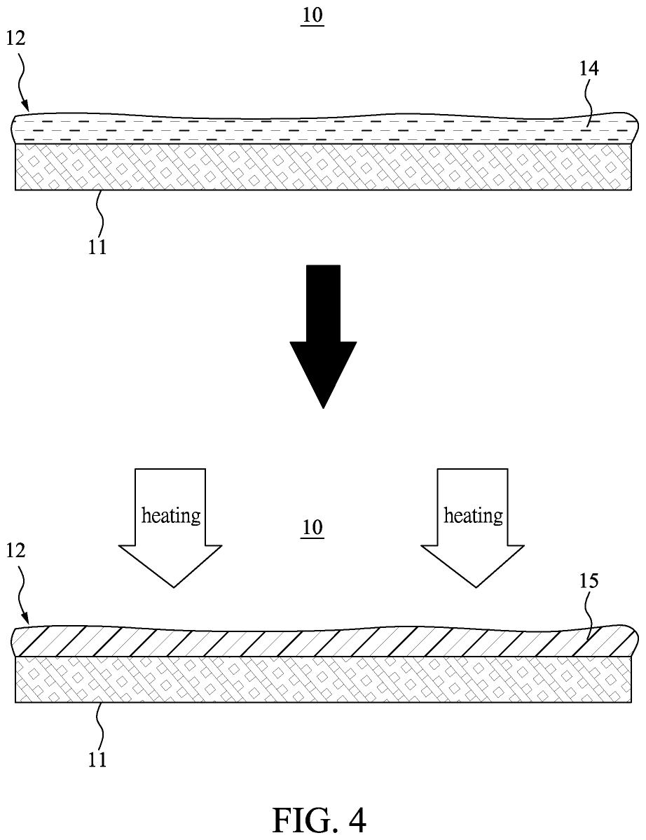

Please refer to FIG. 4. The flow hot-melt adhesive 14 exhausts the water to form a solid hot-melt adhesive 15 after being heated in 80° C.˜200° C. for 0.1 second˜60 seconds, so that the different papers 11 will be bonded to the opposite sides of the solid hot-melt adhesive 15.

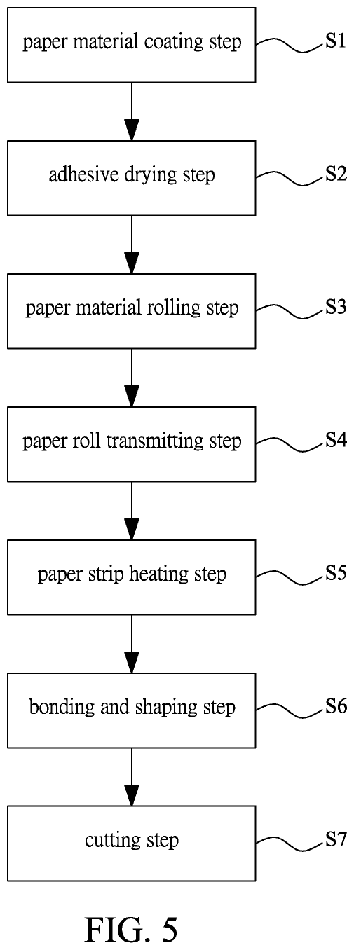

Please refer to FIG. 5. The present invention exposes a paper straw 20. The paper straw 20 is produced by the following steps: a paper material coating step S1: providing the flow hot-melt adhesive on at least one surface of a paper to form a processed paper material; an adhesive drying step S2: drying the flow hot-melt adhesive of the processed paper material, transforming the flow hot-melt adhesive to the dry hot-melt adhesive; a paper material rolling step S3: rolling the processed paper material to form the raw paper roll; a paper roll transmitting step S4: transmitting a raw paper strips toward a connection position jointly by a plurality of raw paper rolls, wherein, the raw paper strip includes a paper material and a dry hot-melt adhesive; a paper strip heating step S5: heating the raw paper strip for transforming the dry hot-melt adhesive of the raw paper strip to a flow hot-melt adhesive; a bonding and shaping step S6: transmitting the raw paper strip to the connection position for rolling jointly, bonding the flow hot-melt adhesive to another raw paper strip respectively to form a pipe; and a cutting step S7: cutting the pipe to form at least one paper straw after the pipe exceeds a setting length.

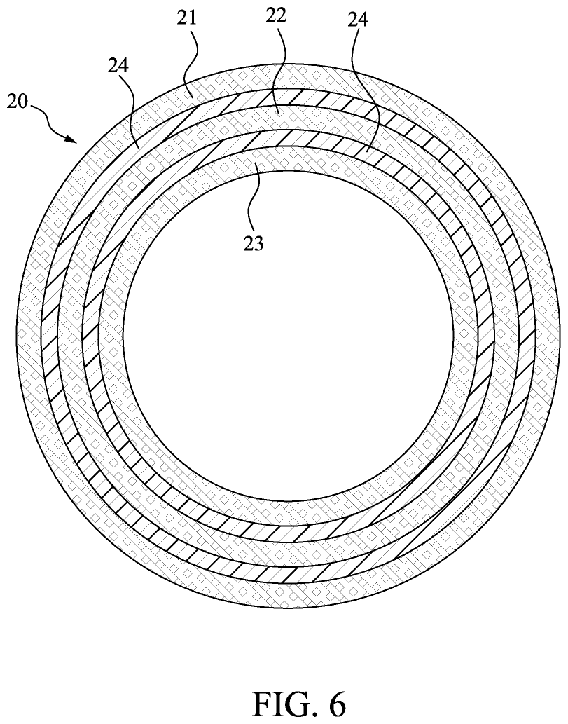

Please refer to FIG. 6. The structure of present invention paper straw 20 includes: an outer paper layer 21, a middle paper layer 22, an inner paper layer 23 and two hot-melt adhesive materials 24. One of the hot-melt adhesive materials 24 is connected between the outer paper layer 21 and the middle paper layer 22, the other hot-melt adhesive materials 24 is connected between the middle paper layer 22 and the inner paper layer 23. The hot-melt adhesive material 24 includes: an acrylic acid copolymer 40%˜45%w/w, an ammonia water less than 0.1% w/w or equal to 0.1% w/w and a water 55%˜60% w/w. The hot-melt adhesive material 24 is presented as a dry hot-melt adhesive without viscosity and transforming from the dry hot-melt adhesive to a flow hot-melt adhesive with viscosity while being heated in 80° C.˜200° C.

Wherein, the width of the outer paper layer is larger than the width of the middle paper layer 22, the width of the middle paper layer 22 is larger than the width of the inner paper layer 23. In an operable embodiment, the size difference of width between the outer paper layer 21, the middle paper layer 22 and the inner paper layer 23 is 0.5 mm.

Similarly, the dry hot-melt adhesive includes a dry adhesive on the outer surface and a flow adhesive being covered by the dry adhesive. The dry adhesive presents a status without viscosity and the flow adhesive presents a status with viscosity. The dry adhesive is broken after being heated, so that the flow adhesive overflows the dry adhesive and mixing with the dry adhesive to form the flow hot-melt adhesive.

The flow hot-melt adhesive exhausts the water to form a solid hot-melt adhesive after being heated in 80° C.˜200° C. for 0.1 seconds˜60 seconds, so that the opposite sides of the solid hot-melt adhesive are bonded to two of the outer paper layer 21, the middle paper layer 22 and the inner paper layer 23.

What is claimed is:

1. A paper material for producing a paper straw, includes:
a paper;
a hot-melt adhesive material, being provided on at least one surface of the paper, including an acrylic acid copolymer 40%˜45%w/w, an ammonia water less than 0.1% w/w or equal to 0.1% w/w and a water 55%˜60%w/w; the hot-melt adhesive material is presented as a dry hot-melt adhesive without viscosity and being transformed to a flow hot-melt adhesive with viscosity while being heated in 80° C.˜200° C.

2. The paper material according to claim 1, wherein the dry hot-melt adhesive includes a dry adhesive on the outer surface and a flow adhesive being covered by the dry adhesive completely, the dry adhesive presents a status without viscosity and the flow adhesive presents a status with viscosity, the dry adhesive is broken after being heated, so the flow adhesive overflows the dry adhesive and mixing with the dry adhesive to form the flow hot-melt adhesive.

3. The paper material according to claim 1, wherein the flow hot-melt adhesive exhausts water to form a solid hot-melt adhesive after being heated for 0.1 second˜60 seconds.

4. A paper straw, include:
an outer paper layer;
a middle paper layer;
an inner paper layer;
two hot-melt adhesive materials, one of the two hot-melt adhesive materials is connected between the outer paper layer and the middle paper layer, the other of the two hot-melt adhesive materials is connected between the middle paper layer and the inner paper layer;
wherein, the hot-melt adhesive material includes: an acrylic acid copolymer 40%˜45% w/w, an ammonia less than 0.1% w/w or equal to 0.1% w/w and a water 55%˜60%, w/w and the hot-melt adhesive material is presented as a dry hot-melt adhesive without viscosity, transforming from a dry hot-melt adhesive to a flow hot-melt adhesive with viscosity after being heated in 80° C.˜200° C.

5. The paper straw according to claim 4, wherein the dry hot-melt adhesive includes a dry adhesive on the outer surface and a flow adhesive being covered by the dry adhesive completely, the dry adhesive presents a status without viscosity and the flow adhesive presents a status with viscosity, the dry adhesive is broken after being heated, so that the flow adhesive overflows the dry adhesive and mixing with the dry adhesive to form the flow hot-melt adhesive.

6. The paper straw according to claim 5, wherein the flow hot-melt adhesive exhausts the water to form a solid hot-melt adhesive after being heated for 0.1 second˜60 seconds.

7. The paper straw according to claim 4, wherein the width of the outer paper layer is larger than the width of the middle paper layer, and the width of the middle paper layer is larger than the width of the inner paper layer.

8. The paper straw according to claim 7, wherein
the size difference of width between the outer paper layer, the middle paper layer and the inner paper layer is 0.5 mm.
